(19) United States
(12) Patent Application Publication
(10) Pub. No.: US 2006/0051003 A1
(43) Pub. Date: Mar. 9, 2006

(54) Fluid dynamic pressure bearing

(75) Inventors: Katsutoshi Nii, Hitachi-shi (JP); Hideo Shikata, Matsudo-shi (JP)

Correspondence Address: OLIFF & BERRIDGE, PLC, P.O. BOX 19928, ALEXANDRIA, VA, 22320, US

(73) Assignee: Hitachi Powdered Metals Co., Ltd., Matsudo-shi (JP)

(21) Appl. No.: 11/214,739

(22) Filed: Aug. 31, 2005

(30) Foreign Application Priority Data
Sep. 6, 2004 (JP) 2004-258287

(51) Int. Cl. F16C 32/06

(52) U.S. Cl. 384/114

(57) ABSTRACT

A cylindrical fluid dynamic pressure bearing includes: a shaft hole which has an inner peripheral surface and into which a shaft is inserted; plural separation grooves formed at equal intervals on the inner peripheral surface in a circumferential direction, the separation grooves extending in an axial direction and dividing the inner peripheral surface in the circumferential direction; and circular arc surfaces formed on the inner peripheral surface between the separation grooves, the circular arc surfaces being eccentric with respect to a center of an outer diameter of the bearing and being inwardly biased toward one circumferential direction, wherein the number of the separation grooves is 3 to 6, the number of the circular arc surfaces is the same as the number of the separation grooves, and the separation groove has a width corresponding to an angle of 8 to 20 degrees in the circumferential direction of which a center is an axial center of the bearing, and has a maximum depth of 0.05 to 0.15 mm.

### BACKGROUND OF THE INVENTION

1. Field of the Invention

The present invention relates to a fluid dynamic pressure bearing which can provide high levels of bearing rigidity by generating a dynamic pressure in a lubricating fluid such as a lubricating oil, and in particular relates to a fluid dynamic pressure bearing desirably used for, for example, spindle motors of compact, thin, and high speed rotation types.

2. Description of Related Art

For example, in various kinds of information devices such as disc drive devices which read and write information from and to a magnetic disc or an optical disc such a CD or a DVD, spindle motors are used as driving devices. In addition, in mirror drive devices such as laser printers, spindle motors are used as driving devices. In the spindle motors, ball bearings are used as bearings, but have limitations of rotation accuracy, high speed, and low noise. Therefore, non-contact types of fluid dynamic pressure bearings superior in the above characteristics have been used. In the fluid dynamic pressure bearings, an oil film composed of lubricating oil is formed in a small gap between a shaft and a bearing, and the oil film is compressed by rotating the shaft, so that the shaft is supported with high rigidity. The fluid dynamic pressure is effectively generated at a recessed portion formed on the shaft or the bearing.

The recessed portion is mainly classified into a radial recessed portion supporting a radial load by generating radial dynamic pressure and a thrust recessed portion supporting a thrust load by generating thrust dynamic pressure. The radial recessed portion is formed on a radial surface (a peripheral surface of the shaft or an inner peripheral surface of the bearing), and has a shape of herringbone grooves or plural (for example, three) circular arc surfaces having centers which are eccentric with respect to that of an outer diameter. The shape and the depth of the groove are designed such that the oil film is more compressed. The circular arc surface is wedge-shaped in cross section such that the small gap between the circular arc surface and the shaft is smaller and narrower in the shaft rotation direction. The thrust recessed portion supporting a thrust load is formed on a thrust surface (an end surface of the shaft or either of facing surfaces of a flange thrust washer and a bearing end surface, wherein the flange thrust washer is provided on the shaft), and has a shape of herringbone grooves or spiral grooves (see Japanese Unexamined Patent Application Publication No. 2001-53683 and Japanese Unexamined Patent Application Publication No. 2002-31223).

The radial recessed portion and the thrust recessed portion for generating dynamic pressure are formed by, for example, chemical etching or electrolysis electric discharge machining, and in particular is formed by plastic working in the case in which the bearing is composed of a sintered material.

Not only size reduction and thickness reduction but also high speed can be remarkably obtained in spindle motors for driving hard discs installed in laptop-type personal computers (PCs). Regarding the size reduction and the thickness reduction, hard discs have become smaller such that the diameter thereof has gone from 3.5 inches to 2.5 inches, and further to approximately 1.8 inches. In accordance with this, a disc driving device has been made thinner such that the overall thickness thereof has gone approximately from 12.5 mm to 5 mm. In accordance with this, a bearing thereof has been unavoidably reduced in size such that an inner diameter thereof has gone approximately from mm to 2 mm and a shaft direction length has reached approximately 2 mm. The size reduction of the bearing causes decrease in bearing rigidity and difficulty in forming a recessed portion for generating dynamic pressure in the above manner.

Regarding the high speed, the rotation speed of the shaft has increased to 4200 rpm to 5400 rpm, and further to 7200 rpm. This high speed causes increase in temperature of the bearing portion. For example, although the temperature of a conventional bearing portion was about 60 degrees C., the temperature of a currently used bearing portion exceeds 80 degrees C. Since the high temperature of the bearing portion causes decrease in viscosity of lubricating oil, in particular a floating amount of the shaft by thrust dynamic pressure on a thrust surface is insufficient, so that contact between metals occurs. Due to this, bearing rigidity and rotation accuracy decrease.

The above high temperature and the above decrease in bearing rigidity due to the size reduction and the thickness reduction cause increase in NRRO value (Non Repetitive RunOut), and difficulty in reading and writing information from and to the disc. From the point of view of high packing density of the disc, shaft run-out of about 1 μm or less is increasingly required.

### SUMMARY OF THE INVENTION

Therefore, an object of the present invention is to provide a high performance fluid dynamic pressure bearing which can have good bearing rigidity even under high temperature conditions as a bearing for motors such as spindle motors of compact, thin, and high speed types.

The Inventors intensively researched on the shapes, the numbers, and the sizes, etc., of the above radial recessed portions and thrust recessed portions for generating dynamic pressure. The Inventors obtained the following findings. That is, the radial recessed portions for generating dynamic pressure are desirably circular arc surfaces, and in the case in which the number of the circular arc surfaces is 3 to 6, the radial recessed portions are easily formed and high bearing rigidity can be obtained. Separation grooves for supplying a lubricating oil between the circular arc surfaces extend in an axial direction, and divide an inner peripheral surface in a circumference direction to separate the circular arc surfaces from each other. The separation grooves are desirably formed so as to divide an inner peripheral surface into 3 to 6 portions in a circumferential direction. The separation groove desirably has a width corresponding to an angle of 8 to 20 degrees in the circumferential direction of which a center is an axial center of the bearing, and has a maximum depth of 0.05 to 0.15 mm.

According to one aspect of the present invention, a cylindrical fluid dynamic pressure bearing was made based on the above findings, and includes: a shaft hole which has an inner peripheral surface and into which a shaft is inserted; plural separation grooves formed at equal intervals on the inner peripheral surface in a circumferential direction, the separation grooves extending in an axial direction and dividing the inner peripheral surface in the circumferential direction; and circular arc surfaces formed on the inner peripheral surface between the separation grooves, the circular arc surfaces being eccentric with respect to a center of an outer diameter of the bearing and being inwardly biased toward one circumferential direction, wherein the number of the separation grooves is 3 to 6, the number of the circular arc surfaces is the same as the number of the separation grooves, and the separation groove has a width corresponding to an angle of 8 to 20 degrees in the circumferential direction of which a center is an axial center of the bearing, and has a maximum depth of 0.05 to 0.15 mm.

The reasons for the above respective numerical conditions are as follows. In the above case in which the number of the circular arc surfaces as the radial recessed portions for generating dynamic pressure is 3 to 6, the radial recessed portions are easily formed, and high bearing rigidity can be obtained. The lubricating oil is held in the above separation grooves, is moved by the rotation of the shaft, and is supplied to a small gap between each circular arc surface and the shaft. As a result, an oil film is formed and a dynamic pressure is generated in the oil film. In the case in which the angle corresponding to the width of the separation groove is less than 8 degrees, the dynamic pressure is higher, but it is difficult to move the lubricating oil by the rotation of the shaft, and the supply of the lubricating oil is insufficient. On the other hand, in the case in which the angle corresponding to the width of the separation groove exceeds 20 degrees, the dynamic pressure decreases, so that bearing rigidity decreases. Therefore, the angle is set to be 8 to 20 degrees. In the case in which the upper limit of the angle corresponding to the width of the separation groove is not more than 15 degrees, sufficient bearing rigidity can be obtained. Therefore, it is more desirable that the angle be not more than 15 degrees.

In the case in which the maximum depth is less than 0.05 mm, negative pressure is generated in the portions of the separation grooves, air is moved, and bubbles are thereby generated. The generation of bubbles causes decrease in bearing rigidity, and the above NRRO value increases. On the other hand, in the case in which the maximum depth of the separation groove exceeds 0.15 mm, the strength of the bearing decreases. For example, in the case in which the fluid dynamic pressure bearing is press-fitted into a housing, stress concentration occurs in the separation grooves, so that the separation grooves are deformed. Therefore, the maximum depth of the separation groove is 0.05 to 0.15 mm.

According to one preferable embodiment of the present invention, the fluid dynamic pressure bearing may further include: plural spiral grooves as the thrust recessed portion formed on an end surface of the fluid dynamic pressure bearing, the spiral grooves extending so as to inwardly curve toward the one circumferential direction, wherein the number of the spiral grooves is 8 to 15, and the spiral groove has a maximum depth of 8 to 15 μm. The reason for the above feature is as follows. In the case in which the number of the spiral grooves is not less than 8, load capacity corresponding to thrust load supporting ability reaches a required level, but in the case in which the number of the spiral grooves exceeds 15, the load capacity corresponding to thrust load supporting ability is saturated. Therefore, the number is desirably 8 to 15. In the case in which viscosity of the lubricating oil decreases at a high temperature of about 80 degrees C., the floating amount of the thrust washer is highest when the depth of the spiral groove is about 10 μm. However, when the depth of the spiral groove exceeds 15 μm, it is difficult to form the spiral groove. Therefore, the depth of the spiral groove is desirably 8 to 15 μm.

A sintered member formed by compacting a material powder into a green compact and sintering the green compact is desirably used for a material of the fluid dynamic pressure bearing of the present invention since the sintered member can be easily plastic worked. The sintered bearing is desirably made of a sintered alloy including 40 to 60 mass % of Fe, 40 to 60 mass % of Cu, and 1 to 5 mass % of Sn, since high working accuracy and high strength can be obtained.

According to the fluid dynamic pressure bearing of the present invention, since the shapes, the numbers, and the sizes, etc., of the radial recessed portions and the thrust recessed portions for generating dynamic pressure are set to the optimum conditions, superior bearing rigidity can be obtained under high temperature conditions, and the fluid dynamic pressure bearing is the most promising as a bearing for motors such as spindle motors of compact, thin, and high speed types.

### BRIEF DESCRIPTION OF THE DRAWINGS

FIG. 1 is a longitudinal cross sectional view of a fluid dynamic pressure bearing of an embodiment according to the present invention.

FIG. 2 is a cross sectional view viewed in a direction of arrow II-II line in FIG. 1.

FIG. 3 is an upper surface diagram of a fluid dynamic pressure bearing of an embodiment.

FIG. 4 is a diagram showing the relationship of a circular arc surface of a fluid dynamic pressure bearing produced in the example and the bearing rigidity (oil film pressure).

FIG. 5 is a diagram showing the relationship of the width of a separation groove of a fluid dynamic pressure bearing produced in the example and the bearing rigidity (oil film pressure).

FIG. 6 is a diagram showing the relationship of the maximum width of a separation groove of a fluid dynamic pressure bearing produced in the example and the bearing rigidity (oil film pressure).

FIG. 7 is a diagram showing the relationship of the number of spiral grooves of a fluid dynamic pressure bearing produced in the example and the floating amount of a shaft.

FIG. 8 is a diagram showing the relationships of the depth of a spiral groove of a fluid dynamic pressure bearing produced in the example and the floating amount of a shaft at 25 degrees C. and 80 degrees C.

### DESCRIPTION OF THE PREFERRED EMBODIMENTS

Embodiments of the present invention will be described hereinafter with reference to the drawings.

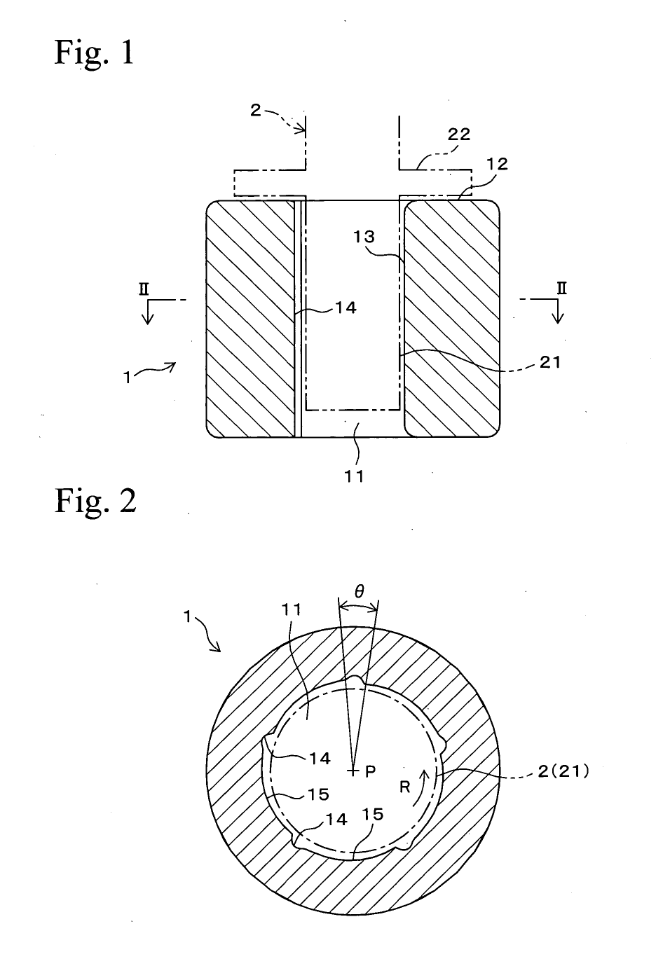

FIG. 1 shows a longitudinal cross sectional view of a fluid dynamic pressure bearing 1 of an embodiment according to the present invention. FIG. 2 is a cross sectional view viewed in the direction of arrow II-II line in FIG. 1. The fluid dynamic pressure bearing 1 has a cylindrical form as shown in the Figures, and is compact so as to have an outer diameter of about 6 mm, and an axial direction length of about 5 mm. The fluid dynamic pressure bearing 1 rotatably supports a shaft 2 which is inserted into a hollow shaft hole 11 and has a diameter of 3 mm.

As shown in FIG. 1, the shaft 2 has a shaft body 21 and a thrust washer 22 fit into the shaft body 21. In the shaft 2, the shaft body 21 is inserted into the shaft hole 11 of the fluid dynamic pressure bearing 1 from the upper side in the Figure, and the thrust washer 22 is disposed to face an upper end surface 12. A radial load of the shaft 2 is received by an inner peripheral surface 13 of the fluid dynamic pressure bearing 1, and a thrust load of the shaft 2 is received by the upper end surface 12 of the fluid dynamic pressure bearing 1. For example, the fluid dynamic pressure bearing 1 of the embodiment is used for spindle motors for hard disc drive devices, and in this case, a magnetic disc is installed on a portion higher than the thrust washer 22 of the shaft body 21 via a rotor hub.

As shown in FIG. 2, five separation grooves 14 are formed at equal intervals in a circumferential direction on the inner peripheral surface 13 of the shaft hole 11 of the fluid dynamic pressure bearing 1. The separation grooves 14 are semi-circular arcs in cross section, and straightly extend from one end surface to the other end surface in an axial direction. Circular arc surfaces 15 are formed between the respective separation grooves 14 of the inner peripheral surface 13. Centers of the circular arc surfaces 15 are eccentric with respect to an axial center P of an outer diameter of the fluid dynamic pressure bearing 1, and the circular arc surfaces 15 are inwardly biased toward one rotation direction of the shaft 2 shown by an arrow R. That is, these circular arc surfaces 15 are eccentric with the outer diameter of the fluid dynamic pressure bearing 1, and the centers of the respective circular arc surfaces 15 exist at equal intervals in the peripheral direction around the axial center P so as to be concentric with respect to the axial center P. In this case, as shown in the Figures, the number of the separation grooves 14 is 5, and the number of the circular arc surfaces 15 is 5. These numbers are desirably 3 to 6.

A small gap between the circular arc surface 15 and the shaft 2 is formed by the above shape of the circular arc surface 15, and is wedge-shaped in cross section so as to be gradually narrower and smaller in the rotation direction of the shaft 2. In this case, a width of the separation groove 14 corresponds to an angle θ of 8 to 20 degrees in the circumferential direction having the axial center P as a center as shown in FIG. 2. The maximum depth of the separation groove 14 is 0.05 to 0.15 mm.

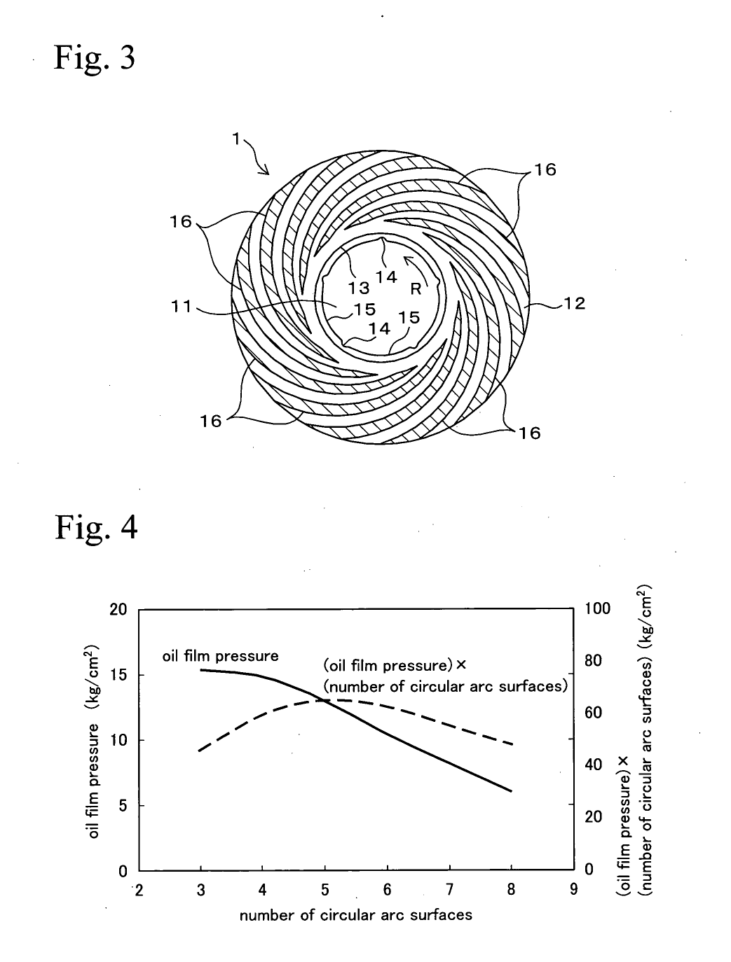

As shown in FIG. 3, plural spiral grooves 16 are formed at equal intervals on the upper end surface 12 of the fluid dynamic pressure bearing 1. The spiral grooves 16 extend so as to inwardly curve toward the rotation direction R of the shaft 2 as shown in FIG. 3. End portions on the peripheral sides of the spiral grooves 16 open to the peripheral surface, and end portions on the inner peripheral sides of the spiral grooves 16 do not open to the inner peripheral surface 13 so as to close. In this case, as shown in the Figures, the number of the spiral grooves 16 is 12, and is desirably 8 to 15. The maximum depth of the spiral groove 16 is 8 to 15 μm.

The fluid dynamic pressure bearing 1 of the embodiment is a sintered bearing formed by compacting a raw powder into a green compact and sintering the green compact. Since the fluid dynamic pressure bearing 1 is the sintered bearing, separation grooves 14, circular arc surfaces 15, and spiral grooves 16 can be easily formed by plastic forming. For example, inner peripheral surface 13 can be formed by press-fitting a male pin into the axial hole 11 of a material of the sintered bearing. The male pin enables forming the separation grooves 14 and the circular arc surfaces 15. Spiral grooves 16 can be formed by pressing a punch on an end surface of a material of the sintered bearing. The punch has plural protrusions enabling forming spiral grooves 16. Since the sintered bearing is porous, the spring-back amount is small, and the separation grooves 14, the circular arc surfaces 15, and the spiral grooves 16 can be formed with high accuracy by plastic working.

A raw powder is desirably used as a material powder, in which an Fe powder, a Cu powder, and a Sn powder are contained, the amount of Fe being nearly equal to the amount of Cu concentration, and the amount of Sn being a few mass %. For example, the amount of Fe is 40 to 60 mass %, the amount of Cu is 40 to 60 mass %, and the amount of Sn is 1 to 5 mass %. In this component, the fluid dynamic pressure bearing 1 is strong not only due to the characteristics of the sintered member of which the main component is Cu which is good for working but also by including large amounts of Fe. The affinity and the plastic working are improved by including Sn. Therefore, the separation grooves 14, the circular arc surfaces 15, and the spiral grooves 16 can be easily formed by plastic working as described above, and the friction coefficient is reduced so that abrasion resistance is improved.

A lubricating oil is impregnated into the above fluid dynamic pressure bearing 1, so that the above fluid dynamic pressure bearing 1 is an oil-impregnated bearing. The shaft 2 inserted into the shaft hole 11 is rotated in the arrow R direction as shown in FIGS. 2 and 3, the lubricating oil is exuded to the respective separation grooves 14 of the inner peripheral surface and is held therein. The lubricating oil held therein is efficiently moved by the shaft 2, and enters into the wedge-shaped small gap between the circular arc surface 15 and the shaft 2, so that an oil film is formed. The lubricating oil entering the small gap flows to the narrower side thereof, and thereby is under high pressure due to the wedge effect, so that a high radial dynamic pressure is generated. Portions under high pressure in the oil film are generated at equal intervals in the peripheral direction in accordance with the circular arc surfaces 15. As a result, the radial load of the shaft 2 is supported in a well-balanced manner to have high rigidity.

On the other hand, the lubricating oil is exuded to the respective spiral grooves 16 formed on the upper end surface of the fluid dynamic pressure bearing 1 and is held therein. One portion of the lubricating oil held therein is discharged from the respective spiral grooves 16 by the rotation of the shaft 2, so that an oil film thereof is formed between the upper end surface 12 and the thrust washer 22. The lubricating oil held in the respective spiral grooves 16 flows from the peripheral side to the inner peripheral side, so that thrust dynamic pressure which is highest at an end portion on the inner peripheral side is generated. The thrust dynamic pressure is received by the thrust washer 22, so that the shaft is floated by a small amount. As a result, the radial load of the shaft 2 is supported in a well-balanced manner so as to have high rigidity.

According to the fluid dynamic pressure bearing 1 of the embodiment, on the radial side, the number of the circular arcs 15 is 3 to 6, and the width of each separation groove 14 for supplying the lubricating oil to the circular arcs 15 corresponds to the angle θ of 8 to 20 degrees, so that the high radial dynamic pressure is generated between each circular arc surface 15 and the shaft 2. As a result, the bearing rigidity is greatly improved. On the other hand, on the thrust side, the number of the spiral grooves 16 is 8 to 15 (12 in the Figures), so that the high thrust dynamic pressure is generated between the upper end surface 12 and the thrust washer 22. The maximum depth of the spiral groove 16 is 8 to 15 μm, so that the thrust dynamic pressure for supporting and floating the shaft 2 is secured even when the temperature of the bearing portion is high at about 80 degrees C. and the viscosity of the lubricating oil decreases.

Since the maximum depth of the separation groove 14 is 0.05 to 0.15 mm, the strength of the fluid dynamic pressure bearing 1 does not degrade. The generation of the negative pressure and the generation of bubbles are inhibited, so that the lubricating oil is sufficiently supplied to the circular arc surfaces 15.

The above fluid dynamic pressure bearing 1 is explained as an example of a fluid dynamic pressure bearing as an oil-impregnated bearing. In the oil-impregnated bearing, there is a case in which a small amount of the generated dynamic pressure is lost from pores. In order to prevent the loss of the dynamic pressure, after the recessed portions for generating dynamic pressure such as the above circular arc portions 15 or the above spiral grooves 16 are provided, the pores of the recessed portions are subjected to sealing such that resins are impregnated into the pores of the recessed portion and are hardened therein, so that the same actions and effects can be obtained.

### EXAMPLES

Next, examples of the present invention will be explained, and the effects of the present invention will be confirmed.

A raw powder having composition shown in Table 1 was compacted into a green compact, and the green compact was sintered, so that the required number of materials of a cylindrical sintered bearing was obtained. The material of a sintered bearing had a true density ratio of 6.3 to 7.2%, an outer diameter of 6 mm, and an axial direction length of 5 mm. Next, the materials of a sintered bearing were worked, and tests regarding the following points A to E were performed thereon.

TABLE 1
(mass %)

| Cu | Sn | Fe |
|---|---|---|
| 40 to 60 | 1 to 5 | 40 to 60 |

Test A. Number of Separation Grooves and Circular Arc Surfaces

Six kinds of sintered bearings having 3 to 8 separation grooves and 3 to 8 circular arc surfaces of inner peripheral surfaces were made. The separation grooves and the circular arc surfaces were formed by plastic working such that a male pin for forming separation grooves and circular arc surfaces was press-fitted into a shaft hole of the material of the sintered bearing. The sintered bearings were press-fitted into a steel housing, and ester oil was impregnated thereinto as lubricating oil. Next, a shaft was inserted into the sintered bearing, and was rotated at 4200 rpm. At this time, oil film pressure (kgf/cm²) generated between the sintered bearing and the shaft was measured. It was decided that as the oil film pressure increases, the bearing rigidity increases. In the example, it was decided that when the oil pressure is about 8 kgf/cm², necessary and sufficient bearing rigidity is secured.

FIG. 4 shows the measurement results. The measured oil film pressure of the sintered bearing having three circular arc surfaces was highest. However, since the bearing rigidity is expressed by the value of (oil film pressure)×(number of circular arc surfaces), that is, the total value of the oil film pressures in the respective circular arc surfaces, it was confirmed that the bearing rigidity of the sintered bearing having 5 circular arc surfaces was highest. When the numbers of the separation grooves and of the circular arc surfaces were 3, it was confirmed that necessary and sufficient bearing rigidity was secured. However, in the case in which the numbers of the separation grooves and of the circular arc surfaces were not less than 7, the bearing surface was much smaller and it was difficult to form, and it was confirmed that the sintered bearing is difficult to use in practice. Therefore, it was confirmed that the numbers of the separation grooves and of the circular arc surfaces are desirably 3 to 6, and the best numbers thereof are 5.

Test B. Width of Separation Groove

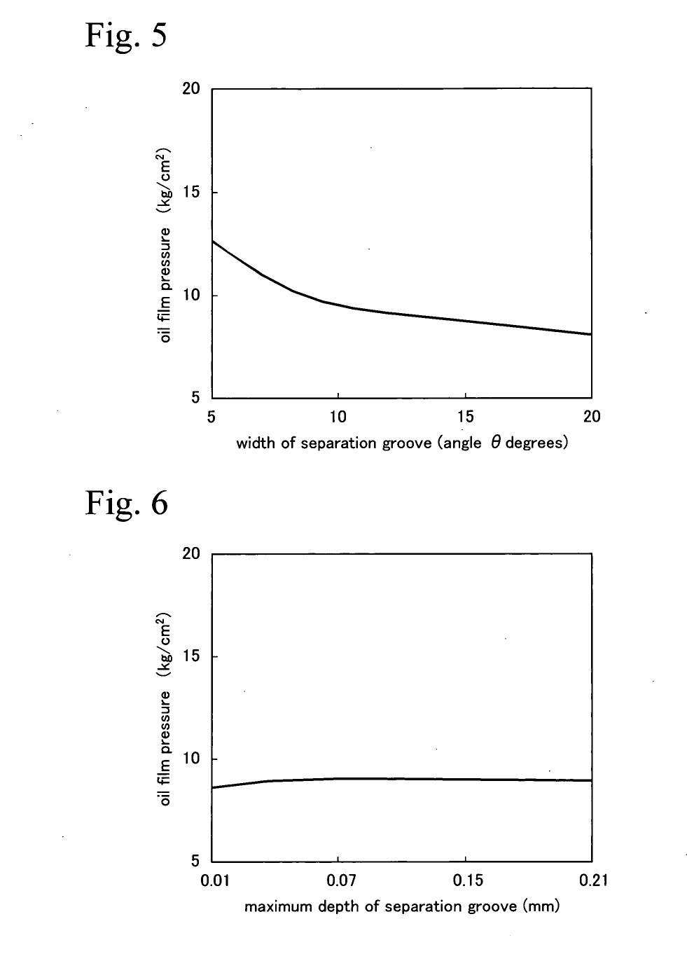

Sixteen kinds of sintered bearings were made such that angles θ of separation grooves shown in FIG. 2 varied by 1 degree within a range of 5 to 20 degrees. By using the sintered bearings, the oil film pressures were measured in the same manner as in the Test A. In the sintered bearings, the numbers of the formed separation grooves and the formed circular arc surfaces were 5. FIG. 5 shows the measurement results. As shown in FIG. 5, it was confirmed that the dynamic pressure increased as the width of the separation groove decreased. However, when the angle θ corresponding to the width of the separation groove was less than 8 degrees, the lubricating oil was difficult to be moved by the shaft, so that the supply of the lubricating oil to the circular arc surface was insufficient. When the angle θ corresponding to the width of the separation groove was 20 degrees, the oil film pressure was 6 kgf/cm², and was the lower limit of the oil film required in practical use. Due to this, when the angle θ exceeds 20 degrees, the necessary and sufficient bearing rigidity is difficult to obtain. When the angle θ is 15 degrees, the oil film pressure is 8 kgf/cm² which is sufficient oil pressure value, so that sufficient rigidity is obtained. Therefore, it was confirmed that the angle θ is desirably 8 to 20 degrees, and is more desirably 8 to 15 degrees.

Test C. Depth of Separation Groove

Nine kinds of sintered bearings were made such that depths of separation grooves thereof varied by 0.02 mm within a range of 0.01 to 0.21 mm. By using the sintered bearings, the oil film pressures were measured in the same manner as in the Test A. In the sintered bearings, the numbers of the formed separation grooves and of the formed circular arc surfaces were 5, and the angles θ were 10 degrees. FIG. 6 shows the measurement results. As shown in FIG. 6, it was confirmed that when the maximum depth of the separation groove was not less than 0.05 mm, the oil film pressure was constant, and when the maximum depth of the separation groove was not more than 0.05 mm, the oil film pressure decreased slightly and varied. The reason for this is as follows. When the maximum depth of the separation groove is not more than 0.05 mm, negative pressure is generated on the separation groove and moves air. The air enters into the bearing surface, so that a pressure drop and a pressure change occur. However, when the maximum depth of the separation groove exceeds 0.15 mm, the overall sintered bearing easily deforms such that the separation grooves are narrower. Due to this, it was confirmed that the maximum depth of the separation groove is desirably 0.05 to 0.15 mm.

Test D. Number of Spiral Grooves

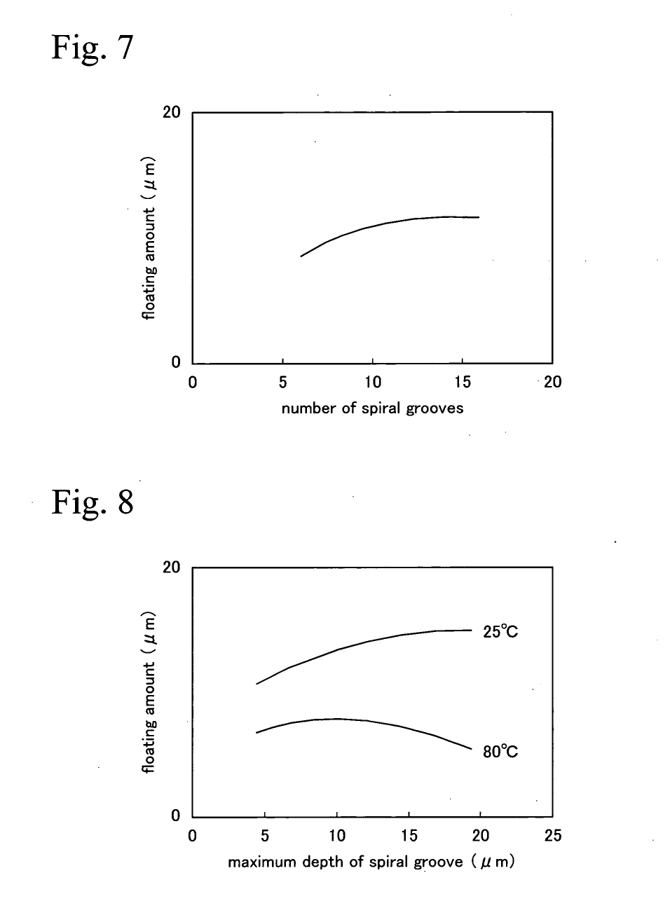

Eleven kinds of sintered bearings were made such that the number of spiral grooves thereof formed on end surfaces was 6 to 16. The spiral grooves were formed by pressing a punch, which has plural protrusions, on an end surface of a material of the sintered bearing. Ester oil as lubricating oil was impregnated into the sintered bearing, and a shaft having a thrust washer was inserted into the sintered bearing such that the thrust washer faced the spiral grooves. The shaft was rotated at 4200 rpm, and the floating amount of the shaft corresponding to a thrust load supporting ability was examined. FIG. 7 shows the measurement results. As shown in FIG. 7, it was confirmed that when the number of the spiral grooves was not less than 8, load capacity reached the required level, but when the number of the spiral grooves exceeded 20, load capacity was saturated.

Test E. Depth of Spiral Groove

Sixteen kinds of sintered bearings were made such that maximum depths of spiral grooves thereof varied by 1 μm within a range of 4 to 19 μm. The spiral grooves were formed in the same manner as in the above Test D. The numbers thereof were 10. At a room temperature of 25 degrees C. and a high temperature of 80 degrees C., the shaft was rotated in the same manner as in the above Test D, and the floating amount of the thrust washer was examined. FIG. 8 shows the results. As shown in FIG. 8, at a room temperature, as the depth of the spiral groove increased, the floating amount of the thrust washer increased. At the high temperature of 80 degrees C., when the depth of the spiral groove was 10 μm, the floating amount of the thrust washer was highest. Therefore, in consideration of temperature conditions thereof at both the room temperature and the high temperature, it was confirmed that the depth of the spiral groove is desirably 8 to 15 μm.

What is claimed is:

1. A cylindrical fluid dynamic pressure bearing comprising:
a shaft hole which has an inner peripheral surface and into which a shaft is inserted;
plural separation grooves formed at equal intervals on the inner peripheral surface in a circumferential direction, the separation grooves extending in an axial direction and dividing the inner peripheral surface in the circumferential direction; and
circular arc surfaces formed on the inner peripheral surface between the separation grooves, the circular arc surfaces being eccentric with respect to a center of an outer diameter of the bearing and being inwardly biased toward one circumferential direction,
wherein the number of the separation grooves is 3 to 6, the number of the circular arc surfaces is the same as the number of the separation grooves, and
the separation groove has a width corresponding to an angle of 8 to 20 degrees in the circumferential direction of which a center is an axial center of the bearing, and has a maximum depth of 0.05 to 0.15 mm.

2. A fluid dynamic pressure bearing according to claim 1, wherein the bearing further comprising:
plural spiral grooves formed on an end surface of the fluid dynamic pressure bearing, the spiral grooves extending so as to inwardly curve toward the one circumferential direction,
wherein the number of the spiral grooves is 8 to 15, and the spiral groove has a maximum depth of 8 to 15 μm.

3. A fluid dynamic pressure bearing according to claim 2, wherein the spiral groove has a width which decreases as the spiral groove inwardly curves toward the one circumferential direction.

4. A fluid dynamic pressure bearing according to claim 2, wherein the spiral groove has a depth which decreases as the spiral groove inwardly curves toward the one circumferential direction.

5. A fluid dynamic pressure bearing according to claim 1, wherein the bearing is a sintered bearing.

6. A fluid dynamic pressure bearing according to claim 5, wherein the bearing is made of a sintered alloy including 40 to 60 mass % of Fe, 40 to 60 mass % of Cu, and 1 to 5 mass % of Sn.
